(19) United States
(12) Patent Application Publication
(10) Pub. No.: US 2018/0300568 A1
(43) Pub. Date: Oct. 18, 2018

(54) DETECTING DEVICE AND METHOD OF DETECTING TARGET OBJECT IN VEHICLE

(71) Applicants: SHENZHEN FUTAIHONG PRECISION INDUSTRY CO., LTD., Shenzhen (CN); FIH (HONG KONG) LIMITED, Kowloon (HK)

(72) Inventors: SHIH-PIN WU, New Taipei (TW); CHUNG-HUI CHEN, New Taipei (TW)

(21) Appl. No.: 15/686,506

(22) Filed: Aug. 25, 2017

(30) Foreign Application Priority Data
Apr. 18, 2017 (CN) 201710252091.1

(51) Int. Cl. G06K 9/00; G06K 9/46; H04N 7/18; B60R 11/04

(52) U.S. Cl. CPC G06K 9/00838; G06K 9/4604; G06K 9/6201; B60R 11/04; H04N 7/188

(57) ABSTRACT

A method for detecting and warning about a human or animal left in a vehicle by a user includes detecting whether the vehicle is in a first condition of engine off and in a second condition of being locked. An image obtaining device is controlled to capture images of interior of the vehicle when the vehicle meets the first and second conditions. Presence of a human or animal is detected by analyzing the images of the current environment inside the vehicle. A preset prompt is transmitted when a human or animal is detected.

### CROSS-REFERENCE TO RELATED APPLICATIONS

This application claims priority to Chinese Patent Application No. 201710252091.1 filed on Apr. 18, 2017, the contents of which are incorporated by reference herein.

### FIELD

The subject matter herein generally relates to automobile safety, and particularly to a detecting device and a method of detecting a target object in a vehicle.

### BACKGROUND

A careless guardian may leave a child alone in a locked car. This is dangerous for the child. Improvement in the art is preferred.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one exemplary embodiment of a vehicle including a detecting device.

FIG. 2 illustrate a flow chart of one exemplary embodiment of a method of detecting a target object in the vehicle.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, referencing the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

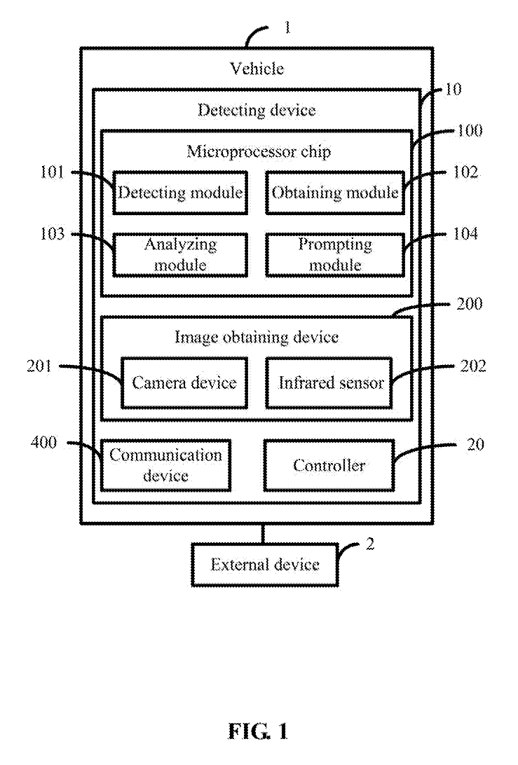

FIG. 1 is a block diagram of one exemplary embodiment of a vehicle. Depending on the exemplary embodiment, the vehicle 1 includes a detecting device 10 and a controller 20. The detecting device 10 can be used to detect whether any passenger is left in the vehicle 1 when a driver of the vehicle 1 is out of the vehicle 1. The detecting device 10 can include, but is not limited to, a microprocessor chip 100, an image obtaining device 200, and a communication device 400. In at least one exemplary embodiment, the image obtaining device 200 is used to capture images of interior of the vehicle 1. In at least one exemplary embodiment, the image obtaining device 200 includes at least one camera device 201 and/or an infrared sensor 202. In at least one exemplary embodiment, the at least one camera device can be a 360-degree panoramic camera, and can be configured at a top position inside the vehicle 1 (e.g., at a position located on a ceiling of the vehicle 1) or can be configured at a position that is near a window of the vehicle 1. The at least one camera device can be used to capture optical images of the current environment inside the vehicle 1. The infrared sensor 202 can be an infrared image sensor. The infrared sensor 202 can capture infrared images of the current environment inside the vehicle 1 by receiving radiation energy inside the vehicle 1 and converting the radiation energy to be image signals.

In at least one exemplary embodiment, the microprocessor chip 100 can be electrically connected with the controller 20. The controller 20 can send an engine off signal to the microprocessor chip 100 when an engine of the vehicle 1 is turned off. The controller 20 can further send a locked signal to the microprocessor chip 100 when doors of the vehicle 1 are locked (e.g., the doors of the vehicle 1 are back locked).

In at least one exemplary embodiment, the communication device 400 can be a subscriber identification module (SIM) card. The detecting device 1 can communicate with an external device 2 through the communication device 400. In at least one exemplary embodiment, the external device 2 can be a mobile phone or a smart watch.

In at least one exemplary embodiment, the microprocessor chip 100 can include, but is not limited to, a detecting module 101, an obtaining module 102, an analyzing module 103, and a prompting module 104. In at least one exemplary embodiment, the modules 101-104 include computerized codes in the form of one or more programs that may be stored in the microprocessor chip 100. The computerized codes include instructions that can be executed by the microprocessor chip 100.

In at least one exemplary embodiment, the detecting module 101 can detect whether the vehicle 1 is in a first condition of engine off and can detect whether the vehicle 1 is in a second condition that doors of the vehicle 1 are locked.

As mentioned above, the controller 20 can send an engine off signal to the microprocessor chip 100 when the engine of the vehicle 1 is turned off, such that the detecting module 101 can determine the vehicle 1 is in the first condition of engine off when the engine off signal is received from the controller 20. Similarly, the detecting module 101 can determine the vehicle 1 is in the second condition when the locked signal is received from the controller 20.

When the vehicle 1 meets the first condition and the second condition, the obtaining module 102 can control the image obtaining device 200 to capture images of a current environment inside the vehicle 1 at preset time intervals (e.g., every second).

In at least one exemplary embodiment, when the vehicle 1 meets the first condition and the second condition, the obtaining module 102 can control the at least one camera device 201 to capture optical images of the current environment inside the vehicle 1 and can control the infrared sensor 202 to capture infrared images of the current environment inside the vehicle 1.

In at least one exemplary embodiment, the analyzing module 103 can determine whether a target object is detected by analyzing the images of the current environment inside the vehicle 1. In at least one exemplary embodiment, the target object can be human or an animal, or other objects that can give off infrared signals.

In at least one exemplary embodiment, the analyzing module 103 can recognize an outline of each object in the images of the current environment inside the vehicle 1 using image edge detection algorithm. The analyzing module 103 can compare the recognized outline with one or more preset outlines to determine whether the target object is detected. When a first similarity degree value between the recognized outline and one of the one or more preset outlines is greater than or equal to a first preset value (e.g., 95%), the analyzing module 103 can determine that the target object is detected. When the first similarity degree value is less than the first preset value, the analyzing module 103 can determine that the target object is not detected.

In at least one exemplary embodiment, the one or more preset outlines can include one or more outlines of objects that can give off infrared signals. For example, the one or more preset outlines can include human outlines, and/or one or more animal outlines.

In other exemplary embodiments, the detecting device 10 pre-stores a reference image which is captured by the image obtaining device 200 under a condition that no target object is inside the vehicle 1, i.e., the reference image is an image of the environment inside vehicle 1 in which there is no human or animal. The analyzing module 103 can compare each of the images of the current environment inside the vehicle 1 and the reference image. When a second similarity degree value between one of the images of the current environment inside the vehicle 1 and the reference image is greater than or equal to a second preset value (e.g., 90%), the analyzing module 103 can determine that a target object is not detected. When the second similarity degree value is less than the second preset value, the analyzing module 103 can determine that a target object is detected.

When the target object is detected, the prompting module 104 can transmit a first preset prompt. In at least one exemplary embodiment, the prompting module 104 can transmit the first preset prompt by activating a horn of the vehicle 1 and/or activating a lighting device of the vehicle 1.

In other exemplary embodiments, the prompting module 104 can transmit a second preset prompt to the external device 2 through the communication device 400. For example, the prompting module 104 can transmit the second preset prompt to a software application that is installed in the external device 2. In at least one exemplary embodiment, the external device 2 can use the software application to access a social network site, and the second preset prompt may be in form of a text message or in a voice message. In other exemplary embodiments, the prompting module 104 can automatically make a telephone call by dialing a phone number of the external device 2 through the communication device 400, such that when a user of the external device 2 answers the call, vocal communication with the target object can take place.

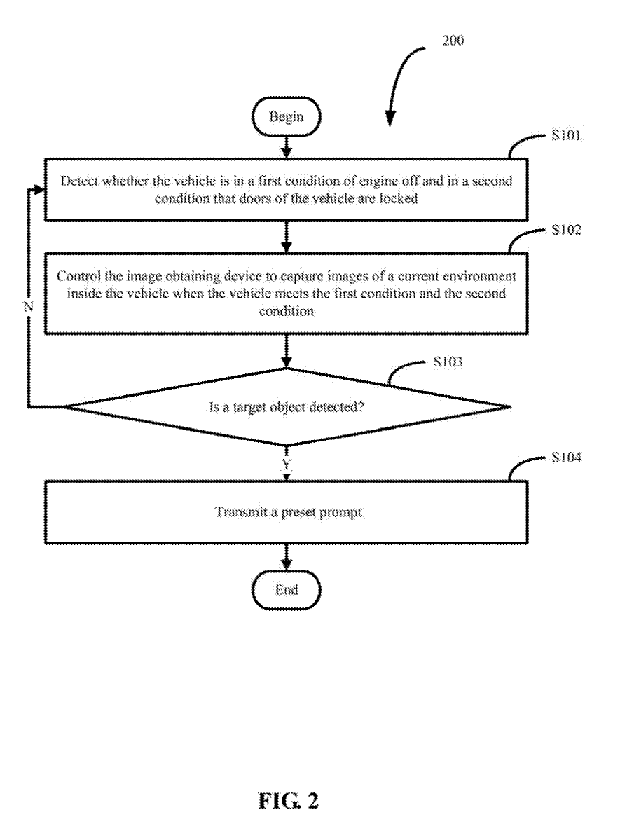

FIG. 2 illustrates a flowchart which is presented in accordance with an example embodiment. The exemplary method 200 is provided by way of example, as there are a variety of ways to carry out the method. The method 200 described below can be carried out using the configurations illustrated in FIG. 1, for example, and various elements of these figures are referenced in explaining exemplary method 200. Each block shown in FIG. 2 represents one or more processes, methods, or subroutines, carried out in the exemplary method 200. Additionally, the illustrated order of blocks is by example only and the order of the blocks can be changed according to the present disclosure. The exemplary method 200 can begin at block S101. Depending on the embodiment, additional steps can be added, others removed, and the ordering of the steps can be changed.

At block S101, the detecting module 101 can detect whether the vehicle 1 is in a first condition of engine off and can detect whether the vehicle 1 is in a second condition that doors of the vehicle 1 are locked.

As mentioned above, the controller 20 can send an engine off signal to the microprocessor chip 100 when the engine of the vehicle 1 is turned off, such that the detecting module 101 can determine the vehicle 1 meets the first condition when the engine off signal is received from the controller 20. Similarly, the detecting module 101 can determine the vehicle 1 meets the second condition when the locked signal is received from the controller 20.

At block S102, when the vehicle 1 meets the first condition and the second condition, the obtaining module 102 can control the image obtaining device 200 to capture images of a current environment inside the vehicle 1 at preset time intervals (e.g., every second).

In at least one exemplary embodiment, when the vehicle 1 meets the first condition and the second condition, the obtaining module 102 can control the at least one camera device 201 to capture optical images of the current environment inside the vehicle 1 and can control the infrared sensor 202 to capture infrared images of the current environment inside the vehicle 1.

At block S103, the analyzing module 103 can determine whether a target object is detected by analyzing the images of the current environment inside the vehicle 1. When the target object is detected, the process goes to block S104. When the target object is not detected, the process goes to block S101. In at least one exemplary embodiment, the target object can be human or an animal, or other objects that can give off infrared signals.

In at least one exemplary embodiment, the analyzing module 103 can recognize an outline of each object in the images of the current environment inside the vehicle 1 using image edge detection algorithm. The analyzing module 103 can compare the recognized outline with one or more preset outlines to determine whether the target object is detected. When a first similarity degree value between the recognized outline and one of the one or more preset outlines is greater than or equal to a first preset value (e.g., 95%), the analyzing module 103 can determine that the target object is detected. When the first similarity degree value is less than the first preset value, the analyzing module 103 can determine that the target object is not detected.

In at least one exemplary embodiment, the one or more preset outlines can include one or more outlines of objects that can give off infrared signals. For example, the one or more preset outlines can include human outlines, and/or one or more animal outlines.

In other exemplary embodiments, the detecting device 10 pre-stores a reference image which is captured by the image obtaining device 200 under a condition that no target object is inside the vehicle 1, i.e., the reference image is an image of the environment inside vehicle 1 in which there is no human or animal. The analyzing module 103 can compare each of the images of the current environment inside the vehicle 1 and the reference image. When a second similarity degree value between one of the images of the current environment inside the vehicle 1 and the reference image is greater than or equal to a second preset value (e.g., 90%), the analyzing module 103 can determine that a target object is not detected. When the second similarity degree value is less than the second preset value, the analyzing module 103 can determine that a target object is detected.

At block S104, when the target object is detected, the prompting module 104 can transmit a first preset prompt. In at least one exemplary embodiment, the prompting module 104 can transmit the first preset prompt by activating a horn of the vehicle 1 and/or activating a lighting device of the vehicle 1.

In other exemplary embodiments, the prompting module 104 can transmit a second preset prompt to the external device 2 through the communication device 400. For example, the prompting module 104 can transmit the second preset prompt to a software application that is installed in the external device 2. In at least one exemplary embodiment, the external device 2 can use the software application to access a social network site, and the second preset prompt may be in form of a text message or in a voice message. In other exemplary embodiments, the prompting module 104 can automatically make a telephone call by dialing a phone number of the external device 2 through the communication device 400, such that when a user of the external device 2 answers the call, vocal communication with the target object can take place.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A detecting device applied to a vehicle, comprising:
a microprocessor chip;
an image obtaining device;
the detecting device storing computerized instructions, which when executed by the microprocessor chip, cause the microprocessor chip to:
detect whether the vehicle is in a first condition of engine off and in a second condition that doors of the vehicle are locked;
control the image obtaining device to capture images of a current environment inside the vehicle when the vehicle is in the first condition of flame-out and in the second condition of back locked;
determine whether a target object is detected by analyzing the images of the current environment inside the vehicle; and
transmit a preset prompt when the target object is detected.

2. The detecting device according to claim 1, wherein the image obtaining device comprises at least a camera device, an infrared sensor, or a combination thereof.

3. The detecting device according to claim 1, wherein analyzing of the images comprises: recognizing an outline of each object in the images using at least one image edge detection algorithm;
comparing the recognized outline with one or more preset outlines;
determining the target object is detected when a first similarity degree value between the recognized outline and one of the one or more preset outlines is greater than or equal to a first preset value; and
determining the target object is not detected when the first similarity degree value is less than the first preset value.

4. The detecting device according to claim 1, wherein analyzing of the images comprises:
comparing each of the images and a reference image, wherein the reference image is captured when no target object is inside the vehicle;
determining the target object is not detected when a second similarity degree between each of the images and the reference image is greater than or equal to a second preset value; and
determining the target object is detected when the second similarity degree is less than the second preset value

5. The detecting device according to claim 1, wherein transmitting of the preset prompt comprises activating a horn of the vehicle, a lighting device of the vehicle, or a combination thereof.

6. The detecting device according to claim 1, wherein transmitting of the preset prompt comprises transmitting a message to an external device or making a telephone call by dialing a phone number of the external device.

7. A detecting method applied to a vehicle comprising an image obtaining device, the method comprising:
detecting whether the vehicle is in a first condition of engine off and in a second condition that doors of the vehicle are locked;
controlling the image obtaining device to capture images of a current environment inside the vehicle when the vehicle is in the first condition of flame-out and in the second condition of back locked;
determining whether a target object is detected by analyzing the images of the current environment inside the vehicle; and
transmitting a preset prompt when the target object is detected.

8. The detecting method according to claim 7, wherein the image obtaining device comprises at least a camera device, an infrared sensor, or a combination thereof.

9. The detecting method according to claim 7, wherein analyzing of the images comprises:
recognizing an outline of each object in the images using image edge detection algorithm;
comparing the recognized outline with one or more preset outlines;
determining the target object is detected when a first similarity degree value between the recognized outline and one of the one or more preset outlines is greater than or equal to a first preset value; and
determining the target object is not detected when the first similarity degree value is less than the first preset value.

10. The detecting method according to claim 7, wherein analyzing of the images comprises:
comparing each of the images and a reference image, wherein the reference image is captured when no target object is inside the vehicle;
determining the target object is not detected when a second similarity degree between each of the images and the reference image is greater than or equal to a second preset value; and
determining the target object is detected when the second similarity degree is less than the second preset value

11. The detecting method according to claim 7, wherein transmitting of the preset prompt comprises activating a horn of the vehicle, a lighting device of the vehicle, or a combination thereof.

12. The detecting method according to claim 7, wherein transmitting of the preset prompt comprises transmitting a message to an external device or making a telephone call by dialing a phone number of the external device.
